(19) United States
(12) Patent Application Publication
(10) Pub. No.: US 2014/0272263 A1
(43) Pub. Date: Sep. 18, 2014

(54) METHOD FOR CONTINUOUS PRODUCTION OF STAIN-RESISTANT NYLON

(71) Applicant: SHAW INDUSTRIES GROUP, INC., DALTON, GA (US)

(72) Inventors: JAMES H. KEEN, DALTON, GA (US); EARL SCHOENBORN, RINGGOLD, GA (US)

(73) Assignee: SHAW INDUSTRIES GROUP, INC., DALTON, GA (US)

(21) Appl. No.: 14/214,608

(22) Filed: Mar. 14, 2014

Related U.S. Application Data
(60) Provisional application No. 61/784,154, filed on Mar. 14, 2013.

(51) Int. Cl. C08G 75/24; A47G 27/02

(52) U.S. Cl. CPC C08G 75/24; A47G 27/02
USPC 428/97; 526/65

(57) ABSTRACT

Disclosed is a process for making an acid dye stain-resistant nylon resin in a continuous multi stage polymerization process. The process provides an acid dye stain-resistant nylon resin of requisite molecular weight at high production rates and a high sulfur content. Also disclosed are fibers, yarns, and textiles comprising the acid dye stain-resistant nylon resin.

### CROSS REFERENCE TO RELATED APPLICATION

This application claims the benefit of and priority to U.S. Provisional Application No. 61/784,154, filed Mar. 14, 2013, which is hereby incorporated herein by reference in its entirety.

### FIELD OF THE INVENTION

The present invention relates generally to a process for making an acid dye stain-resistant nylon resin in a continuous multistage polymerization process. The invention also relates fibers, yarns, and textiles comprising the acid dye stain-resistant nylon resin made by the methods and systems disclosed.

### BACKGROUND OF THE INVENTION

Polyamides, such as nylon 6, can be used as a synthetic fiber. Its structural and mechanical properties make it attractive for use in such capacities as carpets, drapery material, upholstery and clothing. For instance, carpets made from polyamide fibers are a popular floor covering for residential and commercial applications. Such carpets are relatively inexpensive and have a desirable combination of qualities, such as durability, aesthetics, comfort, safety, warmth, and quietness. Furthermore, such carpets are available in a wide variety of colors, patterns and textures.

However, because of presence of cationic charged groups on polyamide (nylon) fibers, such carpets are subject to staining by acid-functional agents (or “acid dyes”), such as those contained in flavored beverages, wine, or coffee.

To reduce the propensity of nylon fibers to stain with acid dyes, various stain blocker treatments have been used. These stain blocker treatments are normally functioning by blocking the negative charges on the fibers so as to prevent acid dyes from attaching to the fibers. Topical treatments are often conventionally applied after the tufting of carpet to impart stain-resistance. Disadvantageously, most topical treatments have been found to be non-durable to water extraction and wear.

In various aspects, stain-resistance can be built-in to polymers by addition of sulfonate groups reacted into the polymer molecule. These groups behave as a stain blocking agent and can repel acid dyes. This influence can also be supplemented by reduction in a number of reactive amine endgroups in the polymer.

The conventional procedure that is known in the art, is based on an addition of a metal salt of sulfoisophthalic acid to the reaction mixture directly into a conventional autoclave reactor for batch polymerization or a VK tube reactor for continuous polymerization, to terminate nearly all of the amine endgroups. At high concentrations, this limits the availability of the polymer endgroups to react and build molecular weight, resulting in a low production rate and a reduced economic benefit.

To minimize a rate-decreasing effect of a stain blocking agent, a rate-promoting agent can be added to the mixture. In this case, the termination can be moderated with the addition of diamine, such as hexamethyline diamine to allow the polymer to reach sufficient molecular weight. As a results, and as one of ordinary skills in the art will appreciate, to produce acid dye stain resistant polymer by addition of stain-blocking agents while keeping high production rates can be challenging. In some cases, the end result can be that either reaction rate and therefore productivity of the polymerization suffers, or less sulfur is added to the polymer by the sulfoisophthalic acid and the stain-resistance suffers; or on the other hand, the polymer is allowed to have more amine endgroups by adding more diamine and the stain resistance suffer.

Accordingly, there is a need to provide a process that improves a stain-resistance of a nylon resin whilst keeping a reaction rate of polymerization high. Further, there is a need to provide a process for producing an acid dye stain-resistant nylon resin in a continuous multi stage polymerization process that can yield the acid dye stain-resistant nylon resin at high production rates. Still further, there is a need for the manufacture of carpet structures comprising said acid dye stain-resistant nylon resin. These needs and other needs are at least partially satisfied by the present invention.

### SUMMARY OF THE INVENTION

In accordance with the purpose(s) of the invention, as embodied and broadly described herein, the invention, in one aspect, relates to a multi-stage process for continuously producing an acid dye stain-resistant nylon resin, comprising the steps of: a) introducing a nylon prepolymer reaction mixture into a prepolymerization zone, wherein the nylon prepolymer reaction mixture comprises: i) a sulfur containing nylon prepolymer reactant; ii) a diamine; iii) a nylon forming monomer; and iv) water; b) reacting at least a portion of the prepolymer reaction mixture in the pre-polymerization zone under conditions effective to provide a sulfonated nylon prepolymer; c) introducing at least a portion of the sulfonated prepolymer into a polymerization zone; and d) polymerizing the sulfonated prepolymer in the polymerization zone under conditions effective to provide a sulfonated nylon polymer having a predetermined molecular weight and a predetermined sulfur content.

Also disclosed herein are acid dye stain-resistant nylon resins produced by the disclosed processes.

Also disclosed herein are fibers manufactured from the acid dye stain-resistant nylon resins.

Also disclosed herein are yarns containing the fibers disclosed herein.

Also disclosed herein are textile compositions, such as, carpet or carpet tiles, comprising the yarns disclosed herein.

Additional aspects of the invention will be set forth, in part, in the detailed description, and claims which follow, and in part will be derived from the detailed description, or can be learned by practice of the invention. It is to be understood that both the foregoing general description and the following detailed description are exemplary and explanatory only and are not restrictive of the invention as disclosed.

### DETAILED DESCRIPTION OF THE INVENTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” may include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used herein, the singular forms “a,” “an” and “the” include plural referents unless the context clearly dictates otherwise. Thus, for example, reference to a “caprolactam” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

As used herein, the term or phrase “effective,” “effective amount,” or “conditions effective to” refers to such amount or condition that is capable of performing the function or property for which an effective amount is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate effective amount will be readily determined by one of ordinary skill in the art using only routine experimentation.

As used herein, the term “substantially,” in, for example, the context “substantially remove,” refers to the removal of at least about 80, 81, 82, 83, 84, 85, 86, 87, 88, 89, 90, 91, 92, 93, 94, 95, 96, 97, 98, 99, 99.9, 99.99, and even 100% of a given component. Thus, in this context, reference to removing “substantially all of the water, ” indicates that at least about 80, 81, 82, 83, 84, 85, 86, 87, 88, 89, 90, 91, 92, 93, 94, 95, 96, 97, 98, 99, 99.9, 99.99, and even 100% of the water is removed.

The terms “amine” or “amino” as used herein are represented by the formula —NA¹A², where A¹ and A² can be, independently, hydrogen or alkyl, cycloalkyl, alkenyl, cycloalkenyl, alkynyl, cycloalkynyl, aryl, or heteroaryl group as described herein. A specific example of amino is —NH₂.

The term “diamine” as used herein refers to a polyamine with exactly two amino groups. Representative diamines include, but are not limited, to the following exemplary groups including ethylenediamine, 1,3-diaminopropane, butane-1,4-diamine, pentane-1,5-diamine, 1,6-diaminohexane, 1,2-diaminopropane, diphenylethylenediamine, diaminocyloxane, o-xylylenediamine, m-xylylenediamine, p-xylylenediamine, o-phenylenediamine, m-phenylenediamine, p-phenylenediamine, dimethyl-4-phenylenediamine, N,N′-di-2-butyl-1,4-phenylenediamine, 4,4′-diaminobiphenyl, 1,8-diaminonaphthalene

The term “amide” as used herein refers to a compound with a functional group containing a carbonyl group linked to a nitrogen atom and is represented by a general formula AₙC(O)ₓNA′₂. Throughout this specification “C(O)” is a short hand notation for a carbonyl group, i.e., C═O. A and A¹ can be a hydrogen, alkyl, cycloalkyl, alkenyl, cycloalkenyl, alkynyl, cycloalkynyl, aryl, or heteroaryl group. A compound with a functional group containing a sulfonyl group linked to a nitrogen atom is called sulfonoamide. “Polyamide” is as the term used to describe any polymer in which the repeating units in the molecular chain are linked together by amide groups.

The term “oligomer” as used herein refers to a molecule that consists of a few monomer units than a polymer. Exemplary oligomers include dimmers, trimers and tetramers.

The term “acid dye site,” as used herein, refers to the basic sites in polyamides, e.g., amine end groups, amide linkages, etc, which react or associate with acid dyes, thereby resulting in staining of the polyamide.

The term “acid dye stain,” as used herein, refers to any material or composition which functions as an acid dyestuff by reacting or associating with the free dye sites in polyamides to substantially permanently color or stain the latter.

The term “stain blocking agent” refers to any material or composition which reacts with a free dye site to prevent formation of an acid dye stain, wherein the polyamide comes into contact with acid dye colorants.

The term “rate-promoting agent,” as used herein, refers to any material or composition that facilitates a polymerization rate and increase in molecular weight of the polyamides.

The term “fiber” as used herein includes fibers of extreme or indefinite length (i.e. filaments) and fibers of short length (i.e., staple fibers).

The term “yarn” as used herein refers to a continuous strand or bundle of fibers.

The term “water extractables” as described herein refers to components of a nylon resin, such as an acid dye stain-resistant nylon resin, which can be extracted with water by washing at a temperature of 100° C. for efficient amount of time. The components of water extractables can include monomeric units of caprolactam, linear oligomers and cyclic oligomers of caprolactam.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

As used herein, and unless the context clearly indicates otherwise, the term carpet is used to generically include broadloom carpet, carpet tiles, and even area rugs. To that “broadloom carpet” means a broadloom textile flooring product manufactured for and intended to be used in roll form. “Carpet tile” denotes a modular floor covering, conventionally in 18″×18,″ 24″×24″ or 36″×36″ squares, but other sizes and shapes are also within the scope of the present invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of preferred embodiments of the invention and the examples included therein and to the Figures and their previous and following description.

As summarized above, disclosed herein is a process for producing an acid dye stain-resistant nylon resin in a continuous multistage polymerization process. An example of a multi-stage polymerization process is described by Twilley et al. in U.S. Pat. No. 3,578,640, and which is hereby incorporated in its entirety by reference. The process generally comprises forming a sulfonated nylon prepolymer in a first prepolymerization zone, and subsequently polymerizing the formed sulfonated nylon prepolymer in a polymerization zone under conditions effective to provide a sulfonated nylon polymer having a desired predetermined molecular weight and predetermined sulfur content. As will be appreciated in view of this disclosure, by using this multistage polymerization process, surprisingly the traditional compromise between endgroup concentration and polymerization rate can be overcome. Moreover, the disclosed process surprisingly provides sulfonated nylon polymers with an improved high sulfur content also without sacrificing polymerization rate, as was also the case in conventional methods.

The sulfonated nylon prepolymer can be formed by introducing a nylon prepolymer reaction mixture into a prepolymerization zone. The nylon prepolymer mixture generally comprises a sulfur containing nylon prepolymer reactant; a diamine; a nylon forming monomer; and water. The nylon prepolymer mixture is reacted in the prepolymerization zone under conditions effective to provide a sulfonated nylon prepolymer. The prepolymerization zone can, for example, be a conventional hydrolysis polymerization reactor. Further, it should be understood that the hydrolysis reaction in the prepolymerization zone can, in some aspects, be a single stage hydrolysis reaction, or in other aspects, can be a multiple stage hydrolysis reaction.

As one skilled in the art can appreciate, the conditions effective to produce the desired sulfonated nylon prepolymer in the prepolymerization zone will depend, at least in part, on the relative amounts of each of the reactant and the desired characteristics of the sulfonated nylon prepolymer being formed. These conditions can be optimized by one skilled in the art using routine methods in view of this disclosure. By way of example, according to aspects of the present invention, in a single stage hydrolysis prepolymerization, the conditions effective can comprise a desired residence time, desired temperature, and desired pressure.

In one aspect, hydrolysis is carried out in at a temperature in the range from about 180° C. to about 300° C., including exemplary temperature range from about 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., and 295° C. Still further, the hydrolysis can be carried out at any temperature within a range of temperatures derived from the above values. For example, the hydrolysis can be carried out at a temperature in the range of from about 200° C. to about 260° C., 220° C. to about 260° C., or even 250° C. to about 260° C.

In one aspect, the hydrolysis reaction can be carried out at any desired pressure in the range effective to and for a time effective to insure reaction. In a further aspect, the reaction can be carried out at ambient pressure, a reduced pressure below ambient pressure, or an elevated pressure above ambient pressure. For example, the hydrolysis reaction can be carried out at a pressure from about 20 psi to about 200 psi, including exemplary pressure ranges from about 30 psi, 40 psi, 50 psi, 60 psi, 70 psi, 80 psi, 90 psi, 100 psi, 110 psi, 120 psi, 130 psi, 140 psi, 150 psi, 160 psi, 170 psi, 180 psi, and 190 psi. Still further, the hydrolysis can be carried out at any pressure within a range of pressures derived from the above values. For example, the hydrolysis can be carried out at a pressure in the range of from about 50 psi to about 150 psi, 70 psi to about 150 psi, or even 100 psi to about 150 psi.

In further aspects, the hydrolysis reaction can be carried for a time effective to insure reaction. In a further aspect, the reaction or reaction step can be performed for a period of time from about 0.5 hours to about 4 hours, including exemplary time period of about 0.6 hours, 0.7 hours, 0.8 hours, 0.9 hours, 1 hours, 1.1 hours, 1.2 hours, 1.3 hours, 1.4 hours, 1.5 hours, 1.6 hours, 1.7 hours, 1.8 hours, 1.9 hours, 2.0 hours, 2.1 hours, 2.2 hours, 2.3 hours, 2.4 hours., 2.5 hours, 2.6 hours, 2.7 hours, 2.8 hours, 2.9 hours, 3 hours, 3.1 hours, 3.2 hours, 3.4 hours, 3.5 hours, 3.6 hours, 3.7 hours, 3.8 hours, and 3.9 hours. Still further, the reaction or reaction step can be carried out for any period of time within a range of time periods derived from the above values. For example, the reaction or reaction step can be carried out at for time period of from about 1 hour to about 3.5 hours, or 1.5 hours about 3 hours.

In alternative aspects, the prepolymerization can comprise a two-stage hydrolysis polymerization process, as described, for example, by Yates et al., in U.S. Pat. No. 4,310,659 and which is hereby incorporated in its entirety by reference. The two-stage hydrolysis generally comprises subjecting the mixture to conditions effective to initiate hydrolysis, and subsequently subjecting the mixture to conditions effective to further hydrolyze the pre-polymer and remove water and water extractables. As described in Yates, an exemplary two-stage hydrolysis prepolymerization comprises a first stage carried out at a temperature of about 180° C., to 260° C., preferably about 200° C. to 230° C. at a pressure of about 20 to 150 psi., preferably 50 to 80 psi. for a period of about 0.5 to 4 hours, preferably for about 1.5 to 3 hours, then before an equilibrium caprolactam conversion condition is reached, a second stage at a temperature of about 200° C., to 260° C., preferably about 210° C. to 240° C., a pressure of about 100 to 900 Torr, preferably about 400 to 600 Torr, for a period of about 2 to 15 hours, preferably 6 to 10 hours, while continuously removing most of the water and some water extractables, so that water and water extractables are removed both during hydrolysis and during polycondensation, whereby the cyclic dimer content of the shaped polymer article is below 0.2 percent by weight.

As noted, the nylon prepolymer reaction mixture comprises a sulfur containing nylon prepolymer reactant, which upon final polymerization is incorporated into the nylon polymer. As one skilled in the art can appreciate this allows stain-resistance to be built into the polymer itself. Incorporation of sulfur-containing chemical moieties such as, for example, sulfonate-containing moieties into the nylon will allow the nylon fibers to repel acid dyes. Thus, these groups can behave as stain blocking agents.

In one aspect, the sulfur containing nylon prepolymer reactant can comprise any suitable sulfonate, or alkali metal salt thereof, which is capable of copolymerizing with a nylon forming monomer, such as a caprolactam. For example, a suitable sulfonate can be a sulfonated dicarboxylic acid, including, for example, aromatic sulfonated dicarboxylic acids. In various aspects, the aromatic sulfonated dicarboxylic acid compound comprises two carboxylic acid moieties in a 1,3 position and the sulfonate moiety in the 5-position. For example, the aromatic compound can comprise a phenyl group with two carboxylic acid moieties and a sulfonate moiety. In various aspects, the sulfur containing nylon prepolymer reactant comprises an aromatic sulfonate, an alkali metal salt of the aromatic sulfonate, or a combination thereof.

The term “sulfonate” refers to a chemical moiety having the structure “—SO₃H,” whereas the term “sulfonate alkali metal salt” to a chemical moiety having the structure “—SO₃M,” wherein M is the cation of the sulfonate salt. The cation of the sulfonate salt can be an alkali metal ion such as Li+, Na+, and K+.

In a further aspect, the sulfonated compounds used in the processes of the present invention are known compounds and may be prepared using methods well known in the art. For example, sulfonated compounds in which the sulfonate group is attached to an aromatic ring may be prepared by sulfonating the aromatic compound with oleum to obtain the corresponding sulfonic acid and followed by reaction with a metal oxide or base, for example, sodium acetate, to prepare the sulfonate salt. Procedures for preparation of various sulfomonomers are described, for example, in U.S. Pat. Nos. 3,779,993; 3,018,272; and 3,528,947.

In a further aspect, non-limiting examples of such sulfonated compounds include sulfonated dicarboxylic acids and the diesters of such diacids. In a still further aspect, the alkali metal salt can be 5-sulfoisophthalic acid or 5-sulfoterphthalic acid. In another aspect, the aromatic sulfonate can be an alkali metal salt of 5-sulfoisophthalic acid.

In a further aspect, sulfonated compound is selected from sulfophthalic acid, sulfoterephthalic acid, sulfoisophthalic acid, 4-sulfonaphthalene-2,7-dicarboxylic acid, and esters of each.

In a further aspect, sulfonated compounds comprise sulfonated styrene, 5-sulfoaryloxycarboxilic acid, 5-sulfoisophthalic acid, or 4-sulfoisiophthalic acid, sulfoalkyloxycarboxilic.

The nylon prepolymer reaction mixture also comprises a nylon forming monomer, which upon final polymerization is incorporated as a repeating unit in the nylon polymer. In various aspects, the nylon forming monomer comprises one or more lactams comprising 4 to 12 carbon atoms. In one aspect, lactams are compounds having the formula:

[chemical structure]

wherein n is an integer from about 3 to about 11. In a further aspect, the lactam is ε-caprolactam having n equal to 5.

It should be understood a stain blocking agent, as described herein, can act can also act as a chain terminator during polymerization of lactams, thus hindering the ability to achieve a desired molecular weight and/or rate of polymerization. For example, the presence of 5-sulfoisophthalic acid as the stain blocking agent at relatively high concentration can act as a difunctional terminator of nylon molecules, thus limiting the availability of polymer endgroups to react and increase chain length. This, in turn, can hinder the polymer production rate through a reactor system. Accordingly, in aspects, it can be desired for the prepolymer reaction mixture to further comprise a rate promoting agent capable of tempering or mitigating the rate decreasing effect of the stain blocking agent. Exemplary rate promoting agents include molecules having at least one additional amine endgroup.

In a further aspect, the processes of the present invention utilize rate promoting agents such as diamines. The diamine can comprise any C6-C12 alkyl and aromatic diamines that are capable of polymerizing with polyamide forming materials. Exemplary useful diamines include aliphatic diamines represented by the formula:

H₂N—(CH₂)ᵣ—NH_{2,}

wherein r is an integer from about 2 to about 12. In a further aspect, the diamine is a C6-C12 aliphatic alkyl diamines. In a yet further aspect, the diamine is hexamethylene diamine or 1,4-bisaminomethylcyclohexane. In a still further aspect, the aliphatic diamine is hexamethylenediamine (H₂N(CH₂)₆NH₂).

In one aspect, one of ordinary skill in the art of formulating nylon polymers will understand that the exact amount of each component in the prepolymer mixture will vary depending on the desired characteristics of the sulfonated prepolymer and, in turn, the resulting polymerized nylon polymer. For example, according to exemplary aspects, and without limitation, the relative amounts of the sulfur containing nylon prepolymer reactant and the diamine component can be in a range of from about a 1:1 molar ratio up to about a 12:1, including relative molar ratios of about 2:1; 3:1, 4:1, 5:1, 6:1, 7:1, 8:1, 9:1, 10:1, and 11:1. Further it should be understood that as the amount sulfur containing nylon prepolymer reactant increases the level of sulfonation in the formed prepolymer and in turn in the resulting nylon polymer will increase. Likewise, the relative amount of nylon forming monomer that can be present in the prepolymer reaction mixture can also vary depending on the desired characteristics of the sulfonated prepolymer and, in turn, the resulting polymerized nylon polymer, and, in particular, depending upon the specific level of sulfonation desired in the final polymerized sulfonated nylon polymer. Thus, one of ordinary skill in the art will be able to readily determine how much nylon forming polymer is desired in the prepolymer mixture, relative to the amount of sulfur containing nylon prepolymer reactant.

In various further exemplary aspects, and without limitation, the relative amount of water in the prepolymer mixture can be in the range of from about 10 wt % to about 50 wt %, wherein the wt % is based upon the total weight of all components in the prepolymer mixture. In a further aspect, the relative amount of water in the prepolymer mixture can be about 10 wt %, 12 wt %, 14%, 15 wt %, 16 wt %, 18 wt %, 20 wt %, 25 wt %, 30 wt %, 35 wt %, 40 wt %, 35 wt %, and 50 wt %.

Prior to the polymerization of the formed sulfonated nylon prepolymer, it is desirable to separate the formed sulfonated nylon prepolymer from water, unreacted nylon forming monomer, unreacted sulfur containing nylon prepolymer reactant, and unreacted diamine. This can, for example, be accomplished by pumping the resulting reaction mixture comprising formed sulfonated nylon prepolymer, water, unreacted nylon forming monomer, unreacted sulfur containing nylon prepolymer reactant, and unreacted diamine through a wiped-wall thin film evaporator to at least substantially remove all of the water and remaining unreacted nylon forming monomer.

The formed sulfonated nylon prepolymer is introduced into a polymerization zone for subsequent polymerization under conditions effective to provide a sulfonated nylon polymer having a desired predetermined molecular weight and a desired predetermined sulfur content. The conditions effective to polymerize can, for example, include those known to one skilled in the art as being suitable for polycondensation reactions. In one aspect, the polymerization zone is provided in the form of a conventional finishing reactor, into which is introduced the formed sulfonated nylon prepolymer. A finishing reactor is capable of creating very high surface area at reduced pressures which facilitates the volatization of water. When water is evaporated from the melt, the polycondensation reaction is driven forward to increase polymer molecular weight. Thus, by using a finishing reactor operating at a reduced pressure, high sulfur concentrations can be obtained at relatively high production rates.

Final polymer properties can be controlled, for example, by agitator speed, polymer temperature, reactor pressure, and residence time. The effect of these variables on final desired polymer properties, e.g. polymer molecular weight, can be monitored by determining the viscosity of the reaction mixture in the finishing reactor. For example, a melt viscosity set-point that corresponds to the target relative viscosity can be monitored in real-time during the reaction in the finishing reactor.

A particular advantage of the disclosed processes is the relatively short residence time needed for polymerization. This relatively short residence time can allow for rapid prototyping and assessment of the impacts of changes in agitator speed, polymer temperature, reactor pressure, and residence time, thus allowing for improved reaction control.

The finishing reactor is preferably operated at reduced pressure, that is, pressures below standard atmospheric pressure. For example, the finishing reactor can be operated at pressures from about 10 Torr to about 700 Torr, including exemplary pressures of about 50 Torr, 100 Torr, 150 Torr, 200 Torr, 250 Torr, 300 Torr, 350 Torr, 400 Torr, 450 Torr, 500 Torr, 550 Torr, 600 Torr, 650 Torr, and 700 Torr, and any range derived therefrom. In a still further aspect, the finishing reactor can be operated below 10 torr, including in the range from about 0.01 Torr to about 10 Torr, including exemplarily pressure ranges of about 0.02 Torr, 0.03 Torr, 0.04 Torr, 0.05 Torr, 0.06 Torr, 0.07 Torr, 0.08 Torr, 0.09 Torr, 0.1 Torr, 0.2 Torr, 0.3 Torr, 0.4 Torr, 0.5 Torr, 0.6 Torr, 0.7 Torr, 0.8 Torr, 0.9 Torr, 1 Torr, 1.5 Torr, 2.0 Torr, 2.5 Torr, 3 Torr, 3.5 Torr, 4 Torr, 4.5 Torr, 5 Torr, 5.5 Torr, 6 Torr, 6.5 Torr, 7 Torr, 7.5 Torr, 8 Torr, 8.5 Torr, 9 Torr, and 9.5 Torr. Still further, the finisher can be kept at any pressure within a range of pressures derived from the above values. For example, the finisher can be kept at a pressure in the range of from about 0.05 Torr to about 5 Torr, about 0.1 Torr about 3 Torr, or even 0.5 Torr to about 1 Torr.

The finishing reactor can be operated at any desired temperature to achieve the desired polymer characteristics. For example, the finishing reactor can be operated at a temperature in the range from about 200° C. to about 300° C., including exemplarily temperature ranges of about 210° C., 215° C., 220° C., 225° C., 230° C., 235° C., 240° C., 245° C., 250° C., 255° C., 260° C., 265° C., 270° C., 275° C., 280° C., 285° C., 290° C., and 295° C. Still further, the finisher can be kept at any temperature within a range of temperatures derived from the above values. For example, the finisher can be kept at a temperature in the range of from about 225° C. to about 285° C., or about 230° C. to about 260° C.

The finishing reactor can be operated at any desired residence time to achieve the desired polymer characteristics. For example, in various aspects, the residence time in the finisher reactor is equal to or less than 1 hours. In another aspect, the residence time is equal to or less than 0.9 hours, 0.8 hours, 0.7 hours, 0.6 hours, 0.5 hours, 0.4 hours, 0.3 hours, 0.2 hours, 0.1 hours.

If desired, the reactions in the prepolymerization zone and/or the polymerization zone can optionally further comprise a catalyst or an initiator. Generally, any known catalyst or initiator suitable for the polymerization can be used. Alternatively, the polymerization can be conducted without a catalyst or initiator. For example, in the synthesis of polyamides from aliphatic dicarboxylic acids and aliphatic diamines, no catalyst is required. For the synthesis of polyamides from lactams, suitable catalysts include water and the omega-amino acids corresponding to the ring-opened (hydrolyzed) lactam used in the synthesis.

Suitable catalysts include water and the omega-amino acids corresponding to the ring-opened (hydrolyzed) lactam used in the synthesis. In various aspects, additional suitable catalysts include metallic aluminum alkylates (MAI(OR)₃H, wherein M is an alkali metal or alkaline earth metal, and R is a C1-C12 alkyl moiety, sodium dihydrobis(2-methoxyethoxy)aluminate, lithium dihydrobis(tert-butoxy)aluminate, aluminum alkylates (e.g. Al(OR)₂R; wherein R is C1-C12 alkyl), N-sodium caprolactam, magnesium chloride or bromide salt of epsilon-caprolactam (MgXC₆H₁₀NO, X═Br or Cl), dialkoxy aluminum hydride. In a further aspect, additional suitable initiators include isophthaloybiscaprolactam, N-acetalcaprolactam, isocyanate epsilon-caprolactam adducts, alcohols (R—OH; wherein R is C1-C12 alkyl), diols (HO—R—OH, wherein R C1-C12 alkylene), omega-aminocaproic acids, and sodium methoxide.

In one aspect, the sulfonated nylon polymer produced by the processes described herein possesses a number of advantageous characteristics. As noted, the incorporation of sulfonated moieties to provide high sulfur content yields a sulfonated nylon polymer with integrated acid dye stain resistant properties. In one aspect, the sulfonated nylon polymer has a sulfur content in the final nylon resin of at least about 500 ppm. In a further aspect, the sulfur content in the final nylon resin of at least about 600, 700, 800, 900, 1000, 1100, 1200, 1200, 1300, 1400, 1500, 1600, 1700, 1800, 1900, 2000, 2100, 2200, 2200, 2300, 2400, or 2500 ppm resin. In another aspect, the sulfur content in the final resin can be at least about 2600, 2700 2800, 3000, 3300, 3500, 3800, 4000, 4300, 4500, 4800, 5000, 5300 5500, 5800, 6000, 6500, 7000, 7500, 8000, 8500, 9000, 9500, 10,000, 10,500, 11,000, 11,500, or 12,000 ppm. In still further aspects, the sulfur content can be within a range derived from any two above exemplified values, for example, a sulfur content from about 500 ppm to about 12,000 ppm.

In one aspect, the sulfonated nylon polymer produced by the processes described comprises desirable levels of amine end groups. For example, in various aspects, the amine endgroup content can be less than 20 meq/kg of the resin, including exemplarily content of less than 19 meq/kg, 18 meq/kg, 17 meq/kg, 16 meq/kg, 15 meq/kg, 14 meq/kg, 13 meq/kg, 12 meq/kg, 11 meq/kg, 10 meq/kg, 9 meq/kg, 8 meq/kg, 7 meq/kg, 6 meq/kg, 5 meq/kg, 4 meq/kg, 3 meq/kg, 2 meq/kg, 1 meq/kg, 0.8 meq/kg, 0.5 meq/kg, 0.3 meq/kg, 0.1 meq/kg, 0.08 meq/kg, 0.05 meq/kg, 0.03 meq/kg, and 0.01 meq/kg of the final resin.

In various aspects, the disclosed processes of the present invention enable the preparation of sulfonated nylon polymers comprising a relatively high sulfur content without sacrificing either the desired molecular weight of the polymer or the production rate of the polymer compared to conventional single polymerization processes performed, for example, in an autoclave reactor for batch polymerization, or a VK tube reactor for continuous polymerization. In a further aspect, the disclosed processes provide sulfonated nylon polymers at an enhanced production rate compared to conventional single step processes. For the purposes of the comparison, it is to be understood that the production rate is the rate at which the desired sulfur content and/or desired polymer molecular weight are achieved. For the purposes of comparison to a conventional or reference process the production rate of the comparative process is the rate to achieve the same desired sulfur content and/or desired molecular weight, but utilizing the conventional single step process. In some aspects, depending upon the desired sulfur content and/or polymer molecular weight, the conventional or reference process may not even be practical. In a further respect, the disclosed processes have an enhanced production rate that is at least 10, 20, 30, 40, 50, 60, 70, 80, 100, 150, 200, or 500% higher than the conventional or reference single step process.

In another aspect, also disclosed herein are the acid dye stain-resistant nylon resins formed by the processes disclosed herein, and having the properties and characteristics disclosed and described herein.

In still another aspect, also disclosed are fibers manufactured from and comprising the disclosed acid dye stain resistant nylon resins. These fibers can be manufacture by any known conventional means, including for example, conventional extrusion processes. Further, the fibers can be provided in the form of long continuous filament fibers or relatively short staple fibers. As will be appreciated, these fibers will similarly exhibit the acid dye stain-resistant properties of the nylon materials disclosed herein.

In further aspects, also disclosed herein are yarns manufactured from and comprising the acid dye stain-resistant nylon fibers disclosed herein. According to aspect, extruded fibers can be made into yarn by various conventional methods known to one of skill in the art. As briefly described herein, after extrusion of the nylon into fibers, the fibers are generally formed into yarn, in particular, a bulked continuous filament yarn, or a staple yarn, in accordance with methods known to one of ordinary skill in the art. In another aspect, techniques for making yarn can involve combining the extruded or as-spun fibers into a yarn, then drawing, texturizing and winding a package, all in a single step.

In another aspect, the yarn formed from the acid dye stain-resistant nylon resin is useful in the manufacture of various textiles, including for example, carpet or carpet tiles. In one aspect, disclosed herein is a carpet or carpet tile comprising the disclosed acid dye stain-resistant nylon resin. For example, in one aspect, the yarn is drawn and texturized to form a bulked continuous filament (BCF) yarn suitable for tufting into carpets and carpet tiles. In yet another aspect, the yarn can be tufted into a pliable primary backing to form a carpet or a carpet tile. In another aspect, the carpet can be tufted carpet, needle-punched carpet, hand woven carpet, broadloom carpet, carpet tile, and even area rugs.

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multi-stage process for continuously producing an acid dye stain-resistant nylon resin, comprising the steps of:
a) introducing a nylon prepolymer reaction mixture into a prepolymerization zone, wherein the nylon prepolymer reaction mixture comprises: i) a sulfur containing nylon prepolymer reactant; ii) a diamine; iii) a nylon forming monomer; and iv) water;
b) reacting at least a portion of the prepolymer reaction mixture in the prepolymerization zone under conditions effective to provide a sulfonated nylon prepolymer;
c) introducing at least a portion of the sulfonated prepolymer into a polymerization zone; and
d) polymerizing the sulfonated pre-polymer in the polymerization zone under conditions effective to provide a sulfonated nylon polymer having a predetermined molecular weight and a predetermined sulfur content.

2. The process of claim 1, wherein the sulfur containing nylon prepolymer reactant comprises an aromatic sulfonate, an alkali metal salt of the aromatic sulfonate, or a combination thereof.

3. The process of claim 1, wherein the sulfur containing nylon prepolymer reactant comprises a sulfonated dicarboxylic acid.

4. The process of claim 1, wherein the sulfur containing nylon prepolymer reactant comprises 5-sulfoisophthalic acid.

5. The process of claim 1, wherein the diamine comprises hexamethylene diamine.

6. The process of claim 1, wherein the nylon forming monomer comprises a caprolactam.

7. The process of claim 1, wherein the nylon forming monomer comprises epsilon caprolactam.

8. The process of claim 1, wherein the sulfur containing nylon prepolymer reactant comprises 5-sulfoisophthalic acid; wherein the diamine comprises hexamethylene diamine; and wherein the nylon forming monomer comprises epsilon caprolactam.

9. The process of claim 1, wherein sulfonated nylon polymer has a sulfur content of at least about 2200 ppm polymer.

10. The process of claim 1, wherein sulfonated nylon polymer has a sulfur content of at least about 2500 ppm polymer.

11. The process of claim 1, wherein the sulfonated nylon polymer has an amine end group content of less than 20 meq/kg per kg of polymer.

12. The process of claim 1, wherein the sulfonated nylon polymer has an amine end group content of less than 10 meq/kg per kg of polymer.

13. The process of claim 1, wherein the prepolymerization zone comprises a hydrolysis polymerization reactor and wherein the conditions effective to provide the sulfonated nylon prepolymer comprise a pressure in the range of from about 20 psi to about 200 psi and a temperature in the range a from about 180° C. to about 280° C.

14. The process of claim 1, wherein the reacting step of b) is performed in two stages comprising: i) subjecting the prepolymer reaction mixture to conditions effective to initiate hydrolysis; and ii) subjecting the prepolymer reaction mixture to conditions effective to further hydrolyze the prepolymer reaction mixture and remove water and water extractables.

15. The process of claim 14, wherein the conditions effective to initiate hydrolysis comprises an elevated pressure from about 20 psi to about 200 psi and a temperature from about 180° C. to about 280° C.

16. The process of claim 14, wherein conditions effective to further hydrolyze the pre-polymer comprises a reduced pressure from about 100 Torr to about 900 Torr and a temperature from about 200° C. to about 280° C.

17. The process of claim 1, wherein the polymerization zone comprises a finishing reactor and wherein the conditions effective to provide the sulfonated nylon polymer comprise a pressure in the range from about 0.01 torr to about 10 torr and a temperature in the range from about 200° C. to about 300° C.

18. The process of claim 17, wherein the conditions effective to provide the sulfonated nylon polymer further comprise a residence time in the polymerization zone of up to about 1 hours.

19. The process of claim 1, wherein the sulfonated nylon polymer has less than about 2.5 percent by weight water extractable material, and less than about 0.2 percent by weight of residual monomer units.

20. The process of claim 1, further comprising the step of extruding the sulfonated nylon polymer to form an acid dye stain-resistant nylon fiber.

21. An acid dye stain-resistant nylon resin formed by the process of claim 1.

22. A yarn comprising the acid dye stain-resistant nylon resin of claim 1.

23. A carpet or carpet tile comprising the yarn of claim 22.
